(19) United States
(12) Patent Application Publication
(10) Pub. No.: US 2010/0196060 A1
(43) Pub. Date: Aug. 5, 2010

(54) DEVELOPER UNIT FOR AN ELECTROPHOTOGRAPHIC PRINTING DEVICE FOR PRINTING ON GLASS OR CERAMIC MATERIAL

(75) Inventors: Dieter Jung, Daaden (DE); Andreas Schoenberger, Emmerzhausen (DE); Christian Hornickel, Nisterberg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: AGC GLASS EUROPE, JUMET (BE)

(21) Appl. No.: 12/597,367

(22) PCT Filed: Apr. 10, 2008
(86) PCT No.: PCT/EP08/02810

§ 371 Date: Mar. 30, 2010

(30) Foreign Application Priority Data
Apr. 24, 2007 (EP) 07008282.1

(51) Int. Cl. G03G 15/08

(52) U.S. Cl. 399/288

(57) ABSTRACT

The invention relates to a developer unit for an electrophotographic printing device for printing on glass or ceramic material having a toner supply and a magnetic roll (22) for applying toner to a photoconductor (10), which is connected to a substrate to be printed, directly or with the interposition of a transfer device (20). According to the invention, a conditioning medium (24) for transferring the toner acts between the magnetic roll (22) and the photoconductor (10).

The invention relates to a developer unit for an electrophotographic printing device for printing on glass or ceramic material having a toner supply and a magnetic roll for applying toner to a photoconductor, which is connected to a substrate to be printed, directly or with the interposition of a transfer device.

Furthermore, the invention relates to an electrophotographic printing device for printing on glass or ceramic material having such a developer unit.

The prior art discloses developer units in which the magnetic roll transfers the developer “flock” directly to the photoconductor. However, the direct contact between the developer flock and the photoconductor is not without problems in the case of functional or rather conductive toners with electric conductivity.

In the case of functional or rather conductive toners a bipolar or opposite polarity is produced, depending on the material used. These charges, which cannot be influenced, lead to an undesired background, contamination and satellite formation on the substrate to be printed.

Since, in the case of conventional two-component systems which use a toner and a carrier and which have direct contact between the magnetic roll and the photoconductor, the speed of the magnetic roll and of the toner flock formed thereon corresponds to about 3 to 4 times that of the photoconductor in order to achieve the desired toner layer thicknesses, smearing, edge effects and the known “brush marks” within areas generally arise. Because of this “wiping effect”, specifically very thin printed lines cannot be produced with sharp edges. In this case, what is known as toner growth occurs, which is deposited laterally on the lines and leads to broadening of the lines.

Depending on the charge of the toner parts adhering to the carrier, it is possible in the case of functional or rather conductive toners for carrier emergence to occur, which leads to the entire printed substrate becoming unusable.

It is therefore an object of the invention to specify a developer unit for an electrophotographic printing device which avoids the aforementioned problems and supplies good printed results.

This object of the invention is achieved by a developer unit for an electro photographic printing device having the features of patent claim 1. Advantageous developments of the developer unit according to the invention are described in the subclaims.

Accordingly, a conditioning medium for transferring the toner acts between the magnetic roll and the photoconductor. Because of the lack of mechanical contact between the magnetic roll and the photoconductor, distortions of the decoration and line broadening no longer occur. The printing speed can thereby be chosen to be very high.

The toner supply can be connected to a supply device which supplies the magnetic roll with a two-component developer, which has at least a toner and a carrier. Between the magnetic roll and the conditioning medium, in this case an electric potential difference acts which at least transfers the toner as a toner flock to the conditioning medium. The toner layer thickness to be expected is to be equated at least to the classic two-component system, it being possible for greater layer thicknesses to be implemented during the development as a result of the higher potential freedom in the developer unit according to the invention.

According to a basic idea of the invention, the conditioning medium can be a closed toner conditioning belt, which is conveyed in the direction from the magnetic roll to the photoconductor. The toner conditioning belt can in this case be substantially composed of an insulating or slightly conductive plastic material. Such a belt is particularly easy to handle and is also well-suited to complex printing devices.

In a particularly simple way, the toner conditioning belt can be guided over a transport roll, which brings the toner conditioning belt into contact with the developer brush of the magnetic roll and at the same time conveys the toner conditioning belt onwards.

In order to achieve particularly simple and effective development of the toner on the toner conditioning belt, an electric potential can be applied to the transport roll for toner development from the magnetic roll onto the toner conditioning belt guided over the transport roll.

According to a further basic idea of the invention, the conditioning medium can be a rotating toner conditioning roll, which is constructed particularly simply. In this case, the toner conditioning roll can substantially comprise a plastic or rubber roll with an insulating or conductive core and an insulating or slightly conductive surface.

In order to control the layer thickness, the speed ratio between the toner conditioning medium and the magnetic roll can be set to about 1:3 to 1:4 via an appropriate motor controller. A further possible way of controlling the layer thickness can be implemented by changing the potentials applied.

In order to avoid holes or “voids” occurring in the printed image, a carrier intercepting device can be arranged after the magnetic roll in the conveying direction of the toner conditioning medium and, by means of magnetic force, remove from the magnetic roll carrier components which have emerged on the toner conditioning medium during the toner development.

In order that no contamination arises as a result of uncharged toner parts or “opposite polarity”, a cleaning roll, to which an electric potential is applied, can be arranged in the conveying direction of the toner conditioning medium, in order to remove particles with opposite charge or uncharged particles.

In order to achieve a uniform homogeneous surface charge before the transfer of the toner to the photoconductor, a toner charging corona for applying additional charge can be arranged on the surface of the toner conditioning medium at a distance from the cleaning roll in the conveying direction of the toner conditioning medium.

In the region in which the surface of the toner conditioning belt or the toner conditioning roll comes into contact with the photoconductor, a transfer corona, to which a direct voltage with a superimposed high-frequency alternating voltage is applied, can be arranged on the rear side of the toner conditioning belt or on the inside of the toner conditioning roll.

During the contact between the photoconductor and the toner conditioning belt, the uniformly charged toner layer is transferred to the photoconductor by the transfer corona. The direct voltage ensures a uniform and intense transfer of toner to the discharged points of the photoconductor; the superimposed alternating voltage ensures improved separation of the toner from the carrier.

The transfer of toner to the photoconductor can be carried out with an equal or approximately equal peripheral speed, so that no distortions or line broadenings occur. The abrasive action of the functional or rather conductive toner on the photoconductor does not occur in the case of equal peripheral speeds, so that a higher efficiency is to be expected.

In the following text, the invention will be explained in more detail by using a preferred embodiment and with reference to the appended drawings, in which:

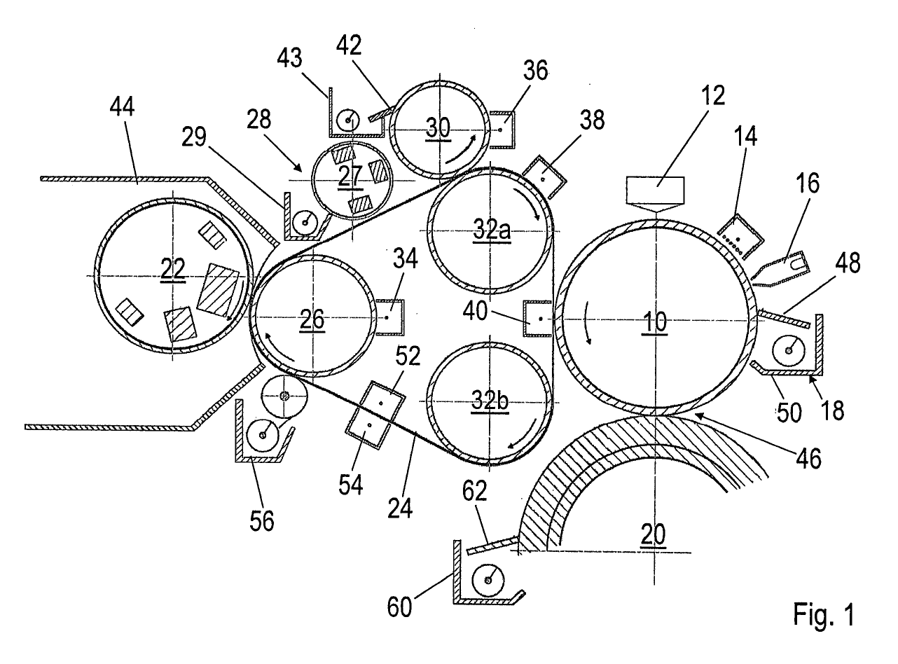

FIG. 1 shows, in a schematic view and in section, an embodiment of the developer unit according to the invention for an electrophotographic printing device for printing on glass or ceramic material, in which a toner conditioning belt guided over a transport roll and two deflection rolls forms the connection between the magnetic roll and the photoconductor;

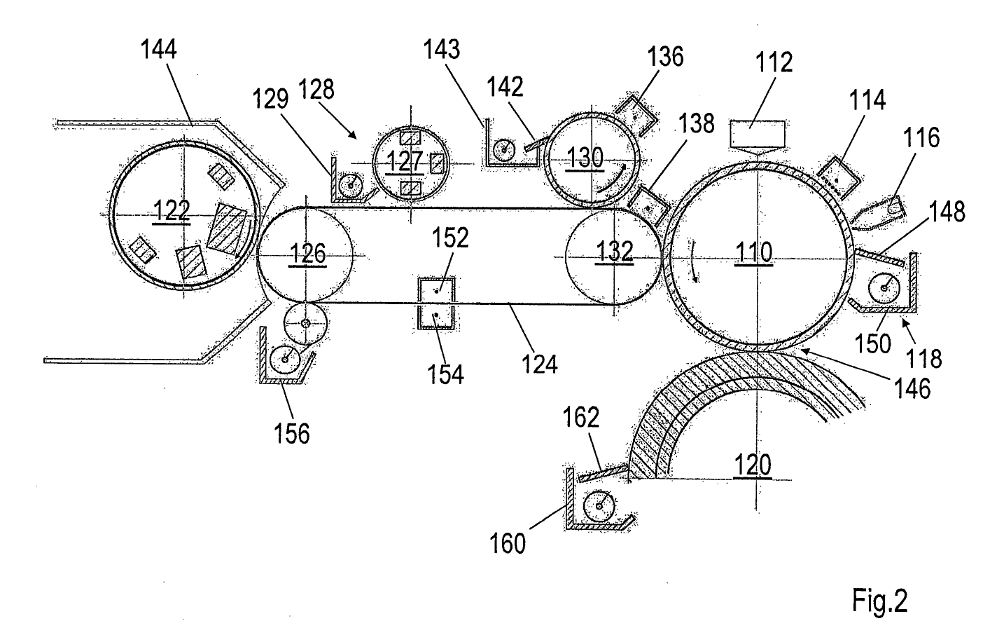

FIG. 2 shows, in a schematic view and in section, another embodiment of the developer unit according to the invention for an electrophotographic printing device, in which a toner conditioning belt guided over a transport roll and a deflection roll forms the connection between the magnetic roll and the photoconductor; and

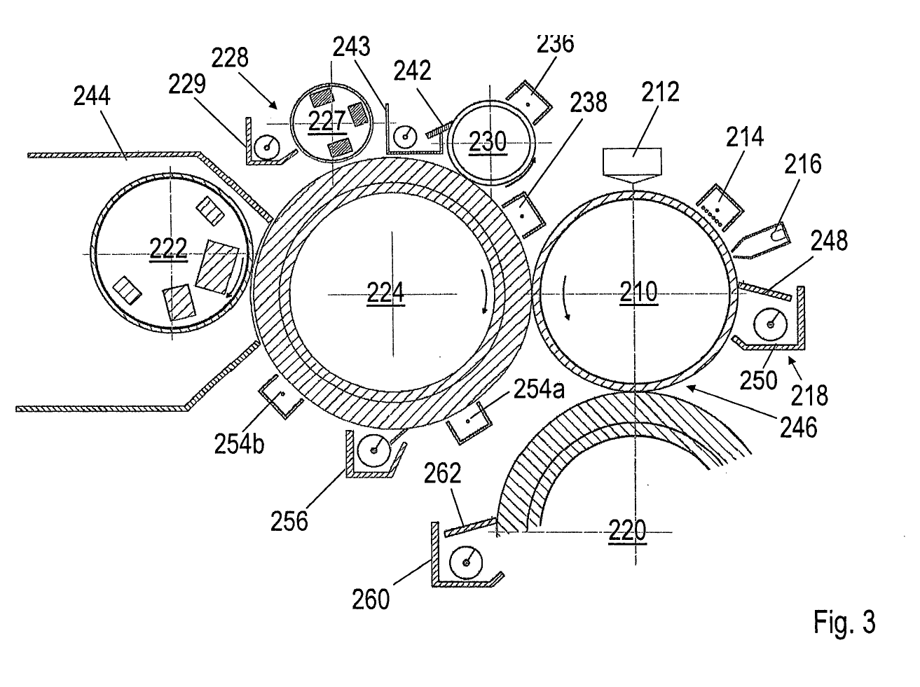

FIG. 3 shows, in a schematic view and in section, yet another embodiment of the developer unit according to the invention for an electrophotographic printing device, in which a toner conditioning roll forms the connection between the magnetic roll and the photoconductor.

FIG. 1 shows, in a schematic view and in section, an embodiment of the developer unit according to the invention for an electrophotographic printing device for printing on glass or ceramic material, in which a toner conditioning belt 24 guided over a transport roll 26 and two deflection rolls 32a and 32b forms the connection between the magnetic roll 22 and the photoconductor 10.

A supply device 44 supplies a two-component developer to the magnetic roll 22 from a storage container. The two-component developer is substantially composed of a functional or rather conductive toner and a carrier. The magnetic roll 22 has a plurality of magnetic poles and forms a magnetic brush by means of magnetic attraction of toner. An electric potential of about −300 to −1000 V DC is applied to the inner core axle of the magnetic roll 22.

There is no direct contact between this developer brush of the magnetic roll 22 of the two-component developer system and the photoconductor 10. Instead, the developer brush of the magnetic roll 22 is separated from the photoconductor 10 by a toner conditioning belt 24. The toner conditioning belt 24 is guided over a transport roll 26, which brings the toner conditioning belt 24 into contact with the developer brush of the magnetic roll 22 and at the same time conveys the toner conditioning belt 24 onwards.

For this purpose, the transport roll 26 is driven by an electric motor (not shown). The toner conditioning belt 24 consists of an only slightly conductive or insulating material. For example, the belt material can be polyimide, which has an electric resistance of about 100 Mohm/cm or else is totally insulating.

The transport roll 26 consists, for example, of an EPDM, NBR or PU foam, is about 960 mm wide and has a diameter of about 40 mm and a Shore hardness A of about 80°. The electric resistance of the transport roll 26 is about 1-10 Mohm/cm.

The toner development from the magnetic roll 22 to the toner conditioning belt 24 can be achieved by an electric potential of about +400 to +500 V DC being applied to the transport roll 26 as a bias voltage. Via the applied potential, the quantity of toner picked up from the magnetic roll 22 onto the toner conditioning belt 24, and the toner flock applied can be controlled. The transport roll 26 is charged appropriately positively by a developer corona 34 arranged on its outer circumference opposite the magnetic roll 22. A further possibility is offered by applying the necessary potential to the roll core or via a charging brush to the surface of the transport roll 26.

The development of the toner onto the toner conditioning belt 24 is carried out under two-component conditions. In order to control the layer thickness, the speed ratio between the toner conditioning belt 24 and the magnetic roll 22 is set to about 1:3 to 1:4 via an appropriate motor controller or an appropriate potential difference.

The toner applied to the toner conditioning belt 24 is cleaned of foreign particles, wrongly charged particles and carrier that has emerged on the way from the magnetic roll 22 to the photoconductor 10.

Arranged after the magnetic roll 22 in the conveying direction of the toner conditioning belt 24 is a suitable carrier intercepting device 28. The carrier intercepting device 28 has a rotating roll 27 arranged directly above the toner conditioning belt 24 and having a plurality of magnetic poles. The roll has a suitable magnetic field strength and, by means of magnetic attraction, removes the carrier components which have possibly emerged during the toner development from the magnetic roll 22 onto the toner conditioning belt 24. In a collecting device 29 arranged on the rotating roll 27 of the carrier intercepting device 28, the carrier components that have been picked up are collected and transported via a suitable screw conveyor into a waste container.

Instead of the rotating roll, the carrier intercepting device 28 can also have a static carrier intercepting magnet (not shown), which removes carrier components which have emerged unintentionally from the toner layer on the toner conditioning belt 24.

Arranged after the carrier intercepting device 28 in the conveying direction of the toner conditioning belt 24 is an electrically conductive cleaning roll 30, which revolves at a speed different from the peripheral speed of the toner conditioning belt 24. The cleaning roll 30 consists, for example, of an EPDM, NBR or PU foam, is about 960 mm wide and has a diameter of about 40 mm and a Shore hardness A of about 80°. The electric resistance of the cleaning roll 30 is about 1-10 Mohm/cm.

A potential of about −400 to −600 V DC is applied to the cleaning roll 30. In this case, the slightly conductive cleaning roll 30 is appropriately charged up negatively on its surface via a corona 36 arranged thereon. Alternatively, a suitable potential can also be applied to the core of the cleaning roll 30 or via a charging brush to the surface of the cleaning roll 30.

On account of the negative charge of the cleaning roll 30, particles with an opposite charge or uncharged particles are picked up. A doctor 42 is arranged on the outer circumference of the cleaning roll 30. The doctor 42 removes the particles picked up from the cleaning roll 30 from the toner flock on the toner conditioning belt 24 and supplies them to a suitable collecting device 43. The particles picked up are collected in the collecting device 43 and transported into a waste container via a suitable screw conveyor.

The toner conditioning belt 24 is deflected in the conveying direction in the direction of the photoconductor 10 by an electrically insulated or slightly conductive deflection roll 32a. The deflection roll 32a consists, for example, of an EPDM, NBR or PU foam, is about 960 mm wide and has a diameter of about 40 mm and a Shore hardness A of about 80°. The electric resistance of the deflection roll 32a is about 1-10 Mohm/cm.

The pure toner particles adhering to the toner conditioning belt 24 after the cleaning roll 30 are then given additional charge via toner charging corona 38, in order that there is on the surface a uniform controllable potential and the toner flock is brought to a uniform charge, which is matched to the following transfer to the photoconductor 10. The toner charging corona 38 is arranged in the conveying direction of the toner conditioning belt 24 at an appropriate distance from the cleaning roll 30 on the deflection roll 32a above the toner conditioning belt 24.

Alternatively, the cleaning roll 30 itself can also be used for recharging the toner flock, since the said roll is already negatively charged.

Arranged after the deflection roll 32a in the conveying direction of the toner conditioning belt 24 is the photoconductor 10, to which the toner on the toner conditioning belt 24 is transferred. The toner is transferred via a transfer corona 40 arranged opposite the photoconductor 10 on the rear side of the toner conditioning belt 24. The transfer corona 40 acts as a direct voltage with superimposed high-frequency alternating voltage of the same polarity as the toner. Since the toner is negatively charged, a potential of −300 to −500 V DC is also applied to the transfer corona 40. The alternating voltage component superimposed on the negative potential and having a frequency of about 500 to 2500 Hz is used to loosen the adhesion forces between the toner particles and the surface of the toner conditioning belt 24. The distance of the corona wire from the toner conditioning belt 24 is particularly small in this case, in order that the alternating voltage comes into effect, cancels the adhesion of the toner to the toner conditioning belt 24 and loosens the toner.

During the contact between the photoconductor 10 and the toner conditioning belt 24, the uniformly charged toner layer is transferred onto the discharged points of the photoconductor 10 by the transfer corona 40. The direct voltage with the superimposed high-frequency alternating voltage ensures a uniform and intense transfer of toner to the discharged points of the photoconductor 10.

According to an alternative embodiment (not shown), instead of the transfer corona 40, an appropriately charged conductive transfer roll having a resistance which is preferably less than 10⁶ ohms can run on the rear side of the toner conditioning belt 24.

In order to assist the transfer of toner, a speed ratio between the toner conditioning belt 24 and the photoconductor 10 of about 1.0-1.3:1 is set, in order that, in addition to the toner being rubbed off, cancellation of the adhesion occurs.

The transfer of toner from the toner conditioning belt 24 to the photoconductor 10 thus takes place at the same or approximately the same peripheral speed, so that no distortions or line broadenings are produced.

The abrasive action of the functional or rather conductive toner on the photoconductor 10 does not occur when the peripheral speeds are equal, so that a higher operational efficiency is to be expected.

In the contact region between the toner conditioning belt 24 and the photoconductor 10, according to a refinement (not shown), it is possible for the formation of an indentation or the forming of a nip between the toner conditioning belt 24 and the photoconductor 10 to occur.

According to an alternative refinement (not shown), a narrow gap can be formed between the toner conditioning belt 24 and the photoconductor 10 at a speed ratio 1:1, which means that a “toner jumping system” is formed, in which the toner overcomes this gap during the transfer from the toner conditioning belt 24 to the photoconductor 10.

The photoconductor 10 is constructed in the form of a roll and, in the region of a contact zone 46, is in linear contact with a transfer roll 20, illustrated only partly in FIG. 1. Provided above the photoconductor 10 is an exposure device 12 having an LED head, which exposes a photosensitive layer of the photoconductor 10 in a known way. In this way, a latent electrostatic charge image is produced. The toner particles are transferred to the transfer roll 20 in the region of the contact zone 46. Any toner residues possibly still adhering to the photoconductor 10 are removed by means of a cleaning device 18, which follows the contact zone 46. Arranged on the outer circumference of the photoconductor 10 is a cleaning blade 48, which removes the toner residues and supplies them to a suitable collecting device 50.

In the collecting device 50, the particles picked up are collected and transported into a waste container via a suitable screw conveyor or supplied to the toner supply again. An extinguishing light bar 16 following the cleaning device 18 discharges the photosensitive layer of the photoconductor.

This photosensitive layer is then brought to a uniform charge structure again by means of a charging corona 14 following the extinguishing light bar 16, so that the photoconductor 10 can be provided with an electrostatic charge image again by the following exposure device 12.

Arranged on the outer periphery of the transfer roll 20 is a doctor 62. The doctor 62 removes the residual toner not transferred to the substrate and supplies it to a suitable collecting device 60. In the collecting device 60, the particles picked up are collected and transported into a waste container via a suitable screw conveyor or supplied to the toner supply again.

During the printing operation, a substrate (not shown) to be printed arranged underneath the transfer roll 20 is displaced linearly and uniformly by means of a transport device. In the process, the transfer roll 20 rolls, either passively or driven, on the surface of the substrate to be printed. The toner which is located on the transfer roll 20 is transferred to the substrate. The substrate can be assigned charging means, which introduce a charge to the surface of the substrate to be printed.

In the conveying direction after the toner transfer region between the toner conditioning belt 24 and the photoconductor 10, the toner conditioning belt 24 is deflected in the direction of the magnetic roll 22 by an electrically insulated or slightly conductive deflection roll 32b. The deflection roll 32b can be constructed in the same way as the deflection roll 32a.

In a collecting device 56 arranged underneath the transport roll 26, the toner particles not transferred to the photoconductor 10 from the toner conditioning belt 24 are collected and supplied to the toner supply again via a suitable screw conveyor.

In order that the toner that is not transferred is kept on the toner conditioning belt 24, a corona 52 brought to positive potential, which charges up the toner conditioning belt 24 positively, can be arranged between the deflection roll 32b and the transport roll 26 on the rear side of the toner conditioning belt 24.

On the front side of the toner conditioning belt 24, opposite the positive corona 52, a further corona 54 is arranged on the toner conditioning belt 24. A negative potential is applied to the corona 54, so that the corona 54 applies additional charge to the residual toner, so that the latter adheres to the positively charged toner conditioning belt 24.

FIGS. 2 and 3 show further embodiments of the invention, which will be described below. The components which have already been described by using FIG. 1 and which have the same function in the embodiments of FIGS. 2 and 3 can be constructed in the same way, so that a detailed description of these components is left out in the following text. In particular, corresponding components can be brought to the same electric potential.

FIG. 2 shows, in a schematic view and in section, another embodiment of the developer unit according to the invention for an electrophotographic printing device, in which a toner conditioning belt 124 guided over a transport roll 126 and a deflection roll 132 forms the connection between the magnetic roll 122 and the photoconductor 110.

A supply device 144 supplies a two-component developer to the magnetic roll 122 from a toner supply. The developer brush of the magnetic roll 122 is separated from the photoconductor 110 by a toner conditioning belt 124. The toner conditioning belt 124 is guided over a transport roll 126, which brings the toner conditioning belt 124 into contact with the developer brush of the magnetic roll 122 and at the same time conveys the toner conditioning belt 124 onwards. A negative potential is applied to the magnetic roll 122.

The toner development from the magnetic roll 122 onto the toner conditioning belt 124 is achieved by a positive electric potential being applied to the transport roll 126. Via the applied potential, the quantity of toner picked up on the toner conditioning belt 124 from the magnetic roll 122 and the toner flock applied can be controlled. The development of the toner onto the toner conditioning belt 124 is carried out under two-component conditions.

Arranged after the magnetic roll 122 in the conveying direction of the toner conditioning belt 124 is a suitable carrier intercepting device 128. The carrier intercepting device 128 has a rotating roll 127 arranged directly above the toner conditioning belt 124 and having a plurality of magnetic poles. By means of magnetic attraction, the rotating roll 127 removes the carrier components which have possibly emerged during the toner development from the magnetic roll 122 onto the toner conditioning belt 124. In a collecting device 129 arranged on the rotating roll 127 of the carrier intercepting device 128, the carrier components that have been picked up are collected and transported via a suitable screw conveyor into a waste container. Instead of the rotating roll, the carrier intercepting device 128 can also have a static carrier intercepting magnet (not shown).

Arranged after the carrier intercepting device 128 in the conveying direction of the toner conditioning belt 124 is an electrically conductive cleaning roll 130, which revolves at a speed different from the peripheral speed of the toner conditioning belt 124. A negative potential is applied to the cleaning roll 130.

In this case, the slightly conductive cleaning roll 130 is appropriately charged up negatively on its surface via a corona 136 arranged thereon. Alternatively, a suitable potential can also be applied to the core of the cleaning roll 130.

On account of the negative charge of the cleaning roll 130, particles with an opposite charge or uncharged particles are picked up. A doctor 142 is arranged on the outer circumference of the cleaning roll 130. The doctor 142 removes the particles picked up from the cleaning roll 130 from the toner flock on the toner conditioning belt 124 and supplies them to a suitable collecting device 143. The particles picked up are collected in the collecting device 143 and transported into a waste container via a suitable screw conveyor.

The toner conditioning belt 124 is deflected in the conveying direction, which runs in the clockwise direction, in the opposite direction by an electrically insulated or slightly conductive deflection roll 132.

The pure toner particles adhering to the toner conditioning belt 124 after the cleaning roll 130 are then given additional charge via a toner charging corona 138, in order that there is on the surface a uniform controllable potential and the toner flock is brought to a uniform charge, which is matched to the following transfer to the photoconductor 110. The toner charging corona 138 is arranged in the conveying direction of the toner conditioning belt 124 at an appropriate distance from the cleaning roll 130 on the deflection roll 132 above the toner conditioning belt 124. The charging corona 138 is merely an optional component and might be omitted.

Alternatively, the cleaning roll 130 itself can also be used for recharging the toner flock, since the said roll is already negatively charged.

Arranged after the deflection roll 132 in the conveying direction of the toner conditioning belt 124 is the photoconductor 110, to which the toner on the toner conditioning belt 124 is transferred. During the contact between the photoconductor 110 and the toner conditioning belt 124, the uniformly charged toner layer is transferred to the photoconductor 110 by the deflection roll 132, which is brought to a negative potential and which runs on the rear side of the toner conditioning belt 124. The deflection roll 132 acts as a negatively charged conductive transfer roll having a resistance which is preferably less than 10⁶ ohms.

The transfer of toner from the toner conditioning belt 124 to the photoconductor 10 thus takes place at the same or approximately the same peripheral speed.

The photoconductor 110 is constructed in the form of a roll and, in the region of a contact zone 146, is in linear contact with a transfer roll 120, illustrated only partly in FIG. 2. Provided above the photoconductor 110 is an exposure device 112 having an LED head, which exposes a photosensitive layer of the photoconductor 110 in a known way. In this way, a latent electrostatic charge image is produced. The toner particles are transferred to the transfer roll 120 in the region of the contact zone 146. Any toner residues possibly still adhering to the photoconductor 110 are removed by means of a cleaning device 118, which follows the contact zone 146. Arranged on the outer circumference of the photoconductor 110 is a cleaning blade 148, which removes the toner residues and supplies them to a suitable collecting device 150. In the collecting device 150, the particles picked up are collected and transported into a waste container via a suitable screw conveyor or supplied to the toner supply again. An extinguishing light bar 116 following the cleaning device 118 discharges the photosensitive layer of the photoconductor 110. This photosensitive layer is then brought to a uniform charge structure again by means of a charging corona 114 following the extinguishing light bar 116, so that the photoconductor 110 can be provided with an electrostatic charge image again by the following exposure device 112.

Arranged on the outer periphery of the transfer roll 120 is a doctor 162. The doctor 162 removes the residual toner not transferred to the substrate and supplies it to a suitable collecting device 160. In the collecting device 160, the particles picked up are collected and transported into a waste container via a suitable screw conveyor or supplied to the toner supply again.

In a collecting device 156 arranged underneath the transport roll 126, the toner particles not transferred to the photoconductor 110 from the toner conditioning belt 124 are collected and supplied to the toner supply again via a suitable screw conveyor.

In order that the toner that is not transferred is kept on the toner conditioning belt 124, a corona 152 brought to positive potential, which charges up the toner conditioning belt 124 positively, is arranged between the deflection roll 132 and the transport roll 126 on the rear side of the toner conditioning belt 124.

On the front side of the toner conditioning belt 124, opposite the positive corona 152, a further corona 154 is arranged on the toner conditioning belt 124. A negative potential is applied to the corona 154, so that the corona 154 applies additional charge to the residual toner, so that the latter adheres to the positively charged toner conditioning belt 124.

FIG. 3 shows, in a schematic view and in section, yet another embodiment of the developer unit according to the invention for an electrophotographic printing device, in which a toner conditioning roll 224 forms the connection between the magnetic roll 222 and the photoconductor 210.

A supply device 244 supplies a two-component developer to the magnetic roll 222 from a toner supply. The developer brush of the magnetic roll 222 is separated from the photoconductor 210 by a toner conditioning roll 224. A negative potential is applied to the magnetic roll 222. The toner conditioning roll 224 comprises, for example, a plastic or rubber roll with an insulating or conductive core and an insulating or slightly conductive surface.

The toner development from the magnetic roll 222 to the toner conditioning roll 224 is achieved by a negative electric potential that is lower as compared with the magnetic roll being applied to the toner conditioning roll 224. Via the applied potential, the quantity of toner picked up on the toner conditioning roll 224 from the magnetic roll 222 and the toner flock applied can be controlled. The development of the toner onto the toner conditioning roll 224 is carried out under two-component conditions. The potential differences can be, for example, in the ratio magnetic roll/toner conditioning roll/exposed photoconductor voltages of −1000/−400/−50 V DC.

A suitable carrier intercepting device 228 is arranged after the magnetic roll 222 in the conveying direction of the toner conditioning roll 224, which runs in the clockwise direction. The carrier intercepting device 228 has a rotating roll 227 arranged directly above the toner conditioning roll 224 and having a plurality of magnetic poles. By means of magnetic attraction, the rotating roll 227 removes the carrier components which have possibly emerged during the toner development from the magnetic roll 222 onto the toner conditioning roll 224. In a collecting device 229 arranged on the rotating roll 227 of the carrier intercepting device 228, the carrier components that have been picked up are collected and transported into a waste container via a suitable screw conveyor. Instead of the rotating roll, the carrier intercepting device 228 can also have a static carrier intercepting magnet (not shown).

Arranged after the carrier intercepting device 228 in the conveying direction of the toner conditioning roll 224 is an electrically conductive cleaning roll 230, which revolves at a speed different from the peripheral speed of the toner conditioning belt 224.

A negative potential is applied to the cleaning roll 230. In this case, the slightly conductive cleaning roll 230 is appropriately charged up negatively on its surface via a cleaning corona 236 arranged thereon. Alternatively, a suitable potential can also be applied to the core of the cleaning roll 230.

On account of the negative charge of the cleaning roll 230, particles with an opposite charge or uncharged particles are picked up. A doctor 242 is arranged on the outer circumference of the cleaning roll 230. The doctor 242 removes the particles picked up from the cleaning roll 230 from the toner flock on the toner conditioning roll 224 and supplies them to a suitable collecting device 243. The particles picked up are collected in the collecting device 243 and transported into a waste container via a suitable screw conveyor.

The pure toner particles adhering to the toner conditioning roll 224 after the cleaning roll 230 are then given additional charge via a toner charging corona 238, in order that there is on the surface a uniform controllable potential and the toner flock is brought to a uniform charge, which is matched to the following transfer to the photoconductor 210. The toner charging corona 238 is arranged above the toner conditioning roll 224 in the direction of rotation of the toner conditioning roll 224 at an appropriate distance from the cleaning roll 230.

Alternatively, the cleaning roll 230 itself can also be used for recharging the toner flock, since the said roll is already negatively charged.

Arranged after the toner charging corona 238 in the conveying direction of the toner conditioning roll 224 is the photoconductor 210, to which the toner on the toner conditioning roll 224 is transferred. During the contact between the photoconductor 210 and the toner conditioning roll 224, the uniformly charged toner layer is transferred to the photoconductor 210 by the toner conditioning roll 224, which is brought to a negative potential.

The transfer of the toner can be carried out via a transfer corona (not shown) arranged opposite the photoconductor 210 on the inner side of the hollow toner conditioning roll 224. In this case, the transfer corona acts as a direct voltage corona with superimposed high-frequency alternating voltage of the same polarity as the toner. Since the toner is negatively charged, a potential of −300 to −500 V DC can also be applied via the transfer corona. The alternating voltage component superimposed on the negative potential and having a frequency of about 500 Hz to 2500 Hz is used to loosen the adhesion forces between the toner particles and the surface of the toner conditioning roll 224. During the contact between the photoconductor 210 and the toner conditioning roll 224, the uniformly charged toner layer is transferred to the photoconductor 210 by the transfer corona. The superimposed alternating voltage ensures a uniform and intense transfer of toner to the discharged points of the photoconductor 210.

The transfer of toner from the toner conditioning roll 224 to the photoconductor 210 takes place at the same or approximately the same peripheral speed.

The photoconductor 210 is constructed in the form of a roll and, in the region of a contact zone 246, is in linear contact with a transfer roll 220, illustrated only partly in FIG. 3. Provided above the photoconductor 210 is an exposure device 212 having an LED head, which exposes a photosensitive layer of the photoconductor 210 in a known way. In this way, a latent electrostatic charge image is produced. The toner particles are transferred to the transfer roll 220 in the region of the contact zone 246.

Any toner residues possibly still adhering to the photoconductor 210 are removed by means of a cleaning device 218, which follows the contact zone 246. Arranged on the outer circumference of the photoconductor 210 is a cleaning blade 248, which removes the toner residues and supplies them to a suitable collecting device 250. In the collecting device 250, the particles picked up are collected and transported into a waste container via a suitable screw conveyor or supplied to the toner supply again. An extinguishing light bar 216 following the cleaning device 218 discharges the photosensitive layer of the photoconductor 210.

This photosensitive layer is then brought to a uniform charge structure again by means of a charging corona 214 following the extinguishing light bar 216, so that the photoconductor 210 can be provided with an electrostatic charge image again by the following exposure device 212.

Arranged on the outer periphery of the transfer roll 220 is a doctor 262. The doctor 262 removes the residual toner not transferred to the substrate and supplies it to a suitable collecting device 260. In the collecting device 260, the particles picked up are collected and transported into a waste container via a suitable screw conveyor or supplied to the toner supply again.

In a collecting device 256 arranged underneath the toner conditioning roll 224, the toner particles not transferred to the photoconductor 210 from the toner conditioning roll 224 are collected and supplied to the toner supply again via a suitable screw conveyor.

In order that the toner that is not transferred is kept on the toner conditioning roll 224, in each case a corona 254a and 254b which applies additional charge to the residual toner is arranged on the surface of the toner conditioning roll 224, on both sides of the collecting device 256.

1. A developer unit for an electrophotographic printing device for printing on glass or ceramic material having a toner supply and a magnetic roll for applying toner to a photoconductor, which is connected to a substrate to be printed, directly or with the interposition of a transfer device,
wherein
a conditioning medium for transferring the toner acts between the magnetic roll and the photoconductor.

2. The developer unit according to claim 1,
wherein
a supply device is connected to the toner supply and supplies the magnetic roll with a two-component developer, which has at least a toner and a carrier, and in that, between the magnetic roll and the conditioning medium, an electric potential difference acts which at least transfers the toner as a toner flock to the conditioning medium.

3. The developer unit according to claim 1,
wherein
the conditioning medium is a closed toner conditioning belt, which is conveyed in the direction from the magnetic roll to the photoconductor.

4. The developer unit according to claim 3,
wherein
the toner conditioning belt comprises an insulating or slightly conductive plastic material.

5. The developer unit according to claim 3,
wherein
the toner conditioning belt is guided over a transport roll, which brings the toner conditioning belt into contact with the developer brush of the magnetic roll and at the same time conveys the toner conditioning belt onwards.

6. The developer unit according to claim 5,
wherein
an electric potential is applied to the transport roll for toner development from the magnetic roll onto the toner conditioning belt guided over the transport roll.

7. The developer unit according to claim 1,
wherein
the conditioning medium is a rotating toner conditioning roll.

8. The developer unit according to claim 7,
wherein
the toner conditioning roll comprises a plastic or rubber roll with an insulating or conductive core and an insulating or conductive surface.

9. The developer unit according to claim 1,
wherein
the speed ratio between the toner conditioning medium and the magnetic roll is 1:2 to 1:5.

10. The developer unit according to claim 1,
wherein
a carrier intercepting device is arranged after the magnetic roll in the conveying direction of the toner conditioning medium and, by means of magnetic force, removes from the magnetic roll carrier components which have emerged on the toner conditioning medium during the toner development.

11. The developer unit according to claim 1,
wherein
a cleaning roll, to which an electric potential is applied, is arranged in the conveying direction of the toner conditioning medium, in order to remove particles with opposite charge or uncharged particles.

12. The developer unit according to claim 11,
wherein
a toner charging corona for applying additional charge is arranged on the surface of the toner conditioning medium at a distance from the cleaning roll in the conveying direction of the toner conditioning medium.

13. The developer unit according to claim 1,
wherein
in the region in which the surface of the toner conditioning belt or the toner conditioning roll comes into contact with the photoconductor, a transfer corona, to which a direct voltage with a superimposed high-frequency alternating voltage is applied, is arranged on the rear side of the toner conditioning belt or on the inside of the toner conditioning roll.

14. The developer unit according to claim 1,
wherein
the peripheral speed of the toner conditioning medium corresponds substantially to the peripheral speed of the photoconductor.

15. An electrophotographic printing device for printing on glass or ceramic material having a developer unit according to claim 1.
